(19) United States
(12) Patent Application Publication
(10) Pub. No.: US 2003/0074454 A1
(43) Pub. Date: Apr. 17, 2003

(54) Method and apparatus for personalized presentation of parametric values

(76) Inventor: Geoffrey Gilbert Peck, San Jose, CA (US)

Correspondence Address: PATRICK REILLY, BOX 7218, SANTA CRUZ, CA, 95061-7218, US

(21) Appl. No.: 10/199,442

(22) Filed: Jul. 20, 2002

Related U.S. Application Data
(60) Provisional application No. 60/307,057, filed on Jul. 20, 2001.

(51) Int. Cl. G06F 15/16

(52) U.S. Cl. 709/228

(57) ABSTRACT

An information presentation personalization system and process. The present invention provides the personalized presentation of structured information from disparate sources such as those available on a network such as the Internet. A network compatible/addressable interface device is operated by a user. The network interface device communicates with local data sources or network accessible data sources via an addressing scheme such as Uniform Resource Locator addresses (URLs) utilized by the Internet. The network interface device retrieves a set of data containing values descriptive of the instantaneous state or measurement of predefined dynamic parameters, such as temperature and barometric pressure. The preferred embodiment presents the retrieved data to the user and indicates by color codes the relationships of the parameter values of the presented data and preset personalized value points. The value points may be set by the user or determined by a calculation or by a third party in view of parameters external to the user and/or the user's characteristics, profile, history and/or personality.

### RELATED APPLICATIONS

This application claims benefit of, and the priority date of, U.S. Provisional Patent Application Ser. No. 60/307,057, filed Jul. 20, 2002.

### FIELD OF THE INVENTION

The present invention relates to information technology systems that provide formatted information to a varied audience of information consumers. The present more particularly relates to a personalized display of information that may be presented in accordance with a pre-established criteria, or user characteristics, or user behavior.

### BACKGROUND OF THE INVENTION

The broadcast and webcast of formatted information to selected and general audiences is a common and increasingly important benefit of Internet and web technologies and networks. The efficiency of providing one to many generation of formatted data is especially useful where one or more key elements of the transmitted information is dynamic and often changing. The capability of the Internet to rapidly update databases and reports and promptly inform a multiplicity of users of the newly acquired and relevant information, by either push or pull information modalities, is helping to provide the benefits of the information age to millions of people around the world.

Yet the continuous delivery of prodigious amounts of information in formatted structures to a large population of recipients often creates an undesirable deluge of data that is sometimes provided in structures that are inefficient for use by many of the receiving population. Individual consumers of information typically have very idiosyncratic interests and needs that are difficult to tailor large information generating and transmitting systems to adjust to or address. The prior art leaves the burden of the inefficiencies of many information formatting and transmitting systems upon the intended recipients of the information, rather than attempt to personalize the presentation of the formatted data to better meet individual tastes and requirements in information prioritization or selection.

There is, therefore, a long felt need to provide formatted data and reports to populations of users in a method that allows each user or many users to flexibly specify priorities of interest by the user in particular types and values of information contained in the provided information and in preferred methods of presentations.

### OBJECTS OF THE INVENTION

It is an object of the present invention to provide a method that enables the personalization of the presentation of data provided by an information system and to an information recipient, consumer or seeker.

It is a further optional object of certain preferred embodiments of the present invention to enable a personalization of the presentation of data provided by an information system in light of a profile that indicates the priorities of the information recipient, consumer or seeker.

It is another optional object of certain alternate preferred embodiments of the present invention to enable a personalization of the presentation of data provided by an information system in light of a profile that indicates one or more properties or characteristics of the information recipient, consumer or seeker.

It is yet another optional object of certain still alternate preferred embodiments of the present invention to enable a personalization of the presentation of data provided by an information system in light of a profile that reflects an act or behavior of the information recipient, consumer or seeker.

### SUMMARY OF THE INVENTION

Towards these and other objects that will be apparent in light of the prior art and this disclosure. The present invention provides a method to present data retrieved or received from a data source and presenting the data, such as a parametric value, to a user in a manner that is personalized to the user. The meaning of the term user as specified herein includes, but is not limited to, information an recipient, an information seeker, an information consumer, an information collector, an information analyzer, and an information amalgamator.

The preferred embodiment includes the use of a network interface computer or device that receives data from the data source via a computer network. The network interface may be, in various preferred embodiments of the present invention, a computer, a network computer, a personal computer, an information appliance, a cell phone, a wireless Internet device, such as a PALM VII wireless interface appliance, a digital pager, a BLACKBERRY wireless Internet, a radio frequency information system or another suitable data communications device known in the art.

Certain preferred embodiments of the method of present invention include the steps of:

1. identifying a data source that contains information of interest to the user;

2. determining how to distinguish particular types of information from the mode or format of storage or reporting of the data source.

3. generating a personalization engine that individually distinguishes at least type of information as stored or provided by or from the data source.

4. generation a personalization profile format or data structure that can inform or be accessed by the personalization engine to identify and specify which information types, and optionally what values of the specified information types, are relevant to the user;

5. the personalization profile format or data structure may optionally have the capability to inform the personalization engine how to modify the presentation of the information received from the data source, e.g., by color coding, by capitalizing, by italicizing, and other suitable information distinguishing techniques known in the art;

6. generating a personalization file by inputting into the personalization format or a data structure the information types and optionally the associated value or values of each, all or some of the information types, that are of interest to the user;

7. sending a query to the data source and receiving a report from the data source, the report being organized as expected by a designer of the personalization engine and the personalization profile;

8. executing an analysis and a reformatting of the report by the personalization engine and in light of the personalization profile; and

9. presenting the reformatted report to the user in a visual mode, an aural mode, a tactile mode, or other suitable information display methods known in the art, in combination or in singularity.

The preferred embodiment includes the creation of a user personalization profile, or profile, that is used to evaluate the data received from the data source. The profile may indicate a certain type of data, such as aeronautic visibility, and a certain value point, e.g., visual flight rated, or ten miles. The profile may inform the network interface on how to present the data referred to in the profile. As an example, the data source may include information concerning the current and forecasted weather conditions within a given geography. The profile may indicate that data concerning wind speeds of greater than 30 miles per hour are to be presented to the user in a text form and with black letters against a red tinted background. Alternatively, the profile may direct the network interface device to present the data in a visual image of a two dimensional map and where areas forecasted to exhibit winds greater than 30 miles per hour are to be shaded with a red color.

The preferred embodiment further enables the profile to direct the network interface device to present data in more than one mode and in comparison to the value point. For example, the profile may inform the network interface device that all areas of the geography that are forecasted to exhibit winds less than 30 miles per hour are to be marked with a green shade on the two dimensional map. In addition, the profile may contain a second value point, such as a value of a wind speed of 50 miles per hour, and the profile may inform the network interface device to that all areas of the geography that are forecasted to exhibit winds greater than 50 miles per hour are to be marked with a gray/black shade on the two dimensional map.

In certain alternate preferred embodiments of the method of the present invention the network interface device may display only that data that compares with that compares with one or more set points of the profile in a prescribed manner. For example, the user might query a database about forecasting wind speeds along a certain flight path. The network interface device would then send an information request for a particular data format that contains wind speed data along with other data. The network interface device would then browse through the data and select out only data that reports current of forecasted presence of wind speeds above the value set point of 30 miles per hour. The network interface device might thereupon present only that data that indicates wind speeds at or above the value set point to the user via either a textual presentation, a two dimensional map, or another suitable visual, aural or tactile data presentation mode known in the art.

In certain still alternate preferred embodiments of the present invention the profile is used by the network interface device to inform the network interface device about a preferred method or style that data contained in a formatted report shall be personalized, organized, ordered, indicated, edited, modified, suppressed, omitted, enhanced and/or prepared and presented to the user. As an example, the user may request a standard report about aeronautic weather and visibility factors. The profile may be structured to direct or inform the network interface device to reorganize the data contained in the report as well as how to visually present the data to the user. The reorganization may include directions or indications about how to sequentially organize the data, e.g., to list all data concerning thunderstorm activity in sequence and before all other data. The network interface device may be directed to suppress or omit data about other specified parameters or conditions, e.g. to suppress data about wind speeds occurring below 500 feet.

In certain yet alternate preferred embodiments of the method of the present invention the steps, aspects and/or execution of the personalization of the data may be distributed between or among two or more computational systems or about a computer network. For example, the network interface device might be a wireless Internet information appliance. The profile might be stored on a first web server and the data source might be located on a computer network that is accessible via a certain universal resource locater, or URL. The user might initiate a request for information from the data source by transmitting a query from the wireless information appliance to a second web server. The second web server might then query the data source URL and acquire a relevant formatted report that contains the information sought by the user. The second web server might then send the received report to the first web server, where a personalization engine prepares a personalized report that is fashioned from the data contained in the formatted report and in light of the information contained in the user profile. The second web server might then send the personalized report via wireless transmission to the network interface device, or the second web server might send the personalized report to the first web server, or another information transmission device in communication with the Internet or another suitable computer network, for follow-on transmission to the wireless device.

In certain still alternate preferred embodiments of the present invention the personalization engine might analyze two or more reports from one or more data sources and reformat the reports into one unified, or two or more distinct personalized reports, where each personalized may contain a combination of information provided by more than data source.

In certain still alternate preferred embodiments of the present invention, the personalization engine computes one or more information representations that are calculated in light of (1) the profile and (2) the information types and values received from one or more data sources, and the personalization engine then reformats and transmits a personalized report containing the results, or reformatted in light of the results, of the computation.

Alternatively or additionally, the network interface device may actualize or execute certain, or all suitable, aspects or steps of a preferred embodiment of the method of the present invention. For example, the profile might be stored on the network interface device and/or the personalization of the report might be accomplished, in part or in toto, by the network interface device.

The personalization process may modify the data found in the formatted report in light of more than one value set point of the profile. For example, the personalization engine might format the personalized report to display in bold text all information relating to the simultaneous location of temperatures below 35 degrees Fahrenheit and wind speeds above 40 miles per hour.

The indication means used in the display of personalized report may optionally include font variations, character size variations, special characters, special alphabets, special icons, common icons, bolded text, colored text, colored or shaded backgrounds, two or three dimensional maps, aural tones, recorded verbal messages, tactile outputs, or other suitable indication methods, perception features or attention attractors known in the art.

The profile of the preferred embodiment specifies the data type of interest to the user, by indicator or position within a report issuing from the data source, or by indicator or position of the information as stored in the data source. The profile optionally indicates the values or values of the specified information type by numerical parameter, label, flag, encrypted value, variable name, constant value name, or another suitable information value known in the art. The profile further informs the personalization engine on how to modify the specified information for presentation or suppression, e.g., by underlining, by bolding, by italicizing, by not presenting, or by other suitable presentation means known in the art. The profile further informs the personalization how to position the information type within the formatted report, e.g., place the associated value of the specified information type first in the report, or last in the report, or proximate to another specified information type or element of the reformatted report, or by another suitable syntactical technique known in the art.

Certain still alternate preferred embodiments of the method of the present invention enable a specific user to store more than one profile for use in personalization the information or report received from a data source. An airplane pilot can, for example, store separate profiles for each of more than one type of aircraft. Or an athlete might store separate profiles that are individually appropriate to one state of several possible states of physical preparedness he or she might be in.

In certain yet alternate preferred embodiments of the method of the present invention, third parties cause personalized reports to be generated or transmitted. Alternatively or additionally, third parties may have the ability to generate, modify or provide user profiles to the personalization engine.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a wireless network interface device in wireless communication with a first data source server having a first data source.

FIG. 2 is a computer network having a communications network, the wireless network interface device of FIG. 1, the first data source server of FIG. 1, a second data source server, a personalization server, a profile generator server, and a profile server.

FIG. 3 illustrates a report generated by the first data source server of FIGS. 1 and 2.

FIG. 4 is a user profile useful by the personalization engine of FIGS. 1 and 2.

FIG. 5 is a personalized report generated by the personalization engine of FIGS. 1 and 2 and in light of the user profile of FIG. 4 and as processed in combination with the report of FIG. 3.

FIG. 6 is a flow chart of the method of the present invention as actualized in FIGS. 1 thru 5.

FIG. 7 is a schematic diagram of the process on an alternate preferred embodiment of the method of the present invention.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

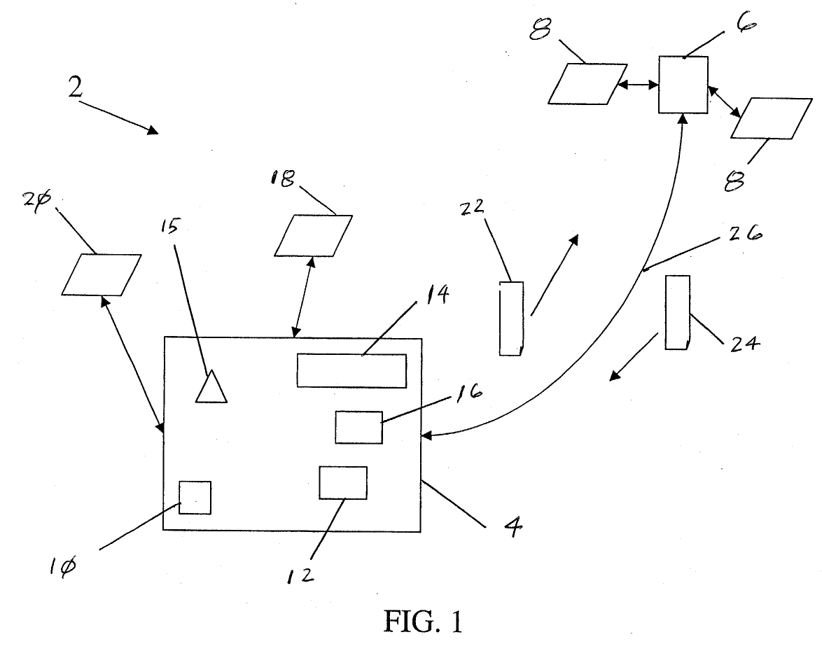

Referring now generally to the Figures and particularly to FIG. 1, a wireless preferred embodiment of the present invention, or wireless system 2, includes a wireless network interface device in wireless communication with a first data source server 6 having a first data source. The wireless network interface device, or wireless device, is a computational device and has a user input module, such a keyboard or a microphone, and a presentation device, such as a video display or an audio speaker. The wireless device my be or comprise a wireless network appliance, such as a PALM VII wireless network communications appliance, or a cell phone with a data presentation aspect or module. The wireless device contains a microprocessor and memory sufficient to store and execute a personalization engine and a user profile. In operation, the user, or the wireless device either automatically, or per a time schedule, or in response to an event or condition, initiates a request for data from the first data server. Alternatively, the first data server may independently generate a report having information and transmit the report to the wireless device, either automatically, or per a time schedule, or in response to an event or condition. The user may user the input module to initiate a request for information to the first data server. The report transmits from the first data server via the communications link to the wireless device. The communications link may be or include a radio frequency, a cell phone channel, a wireless Internet communications modality or another suitable wireless information communications method or apparatus known in the art. The wireless device receives the transmitted data or information and reformats the report into a personalized report by processing the received information with or via the personalization engine and in light of the personalization profile. The wireless device then presents the personalized report to the user via the display module.

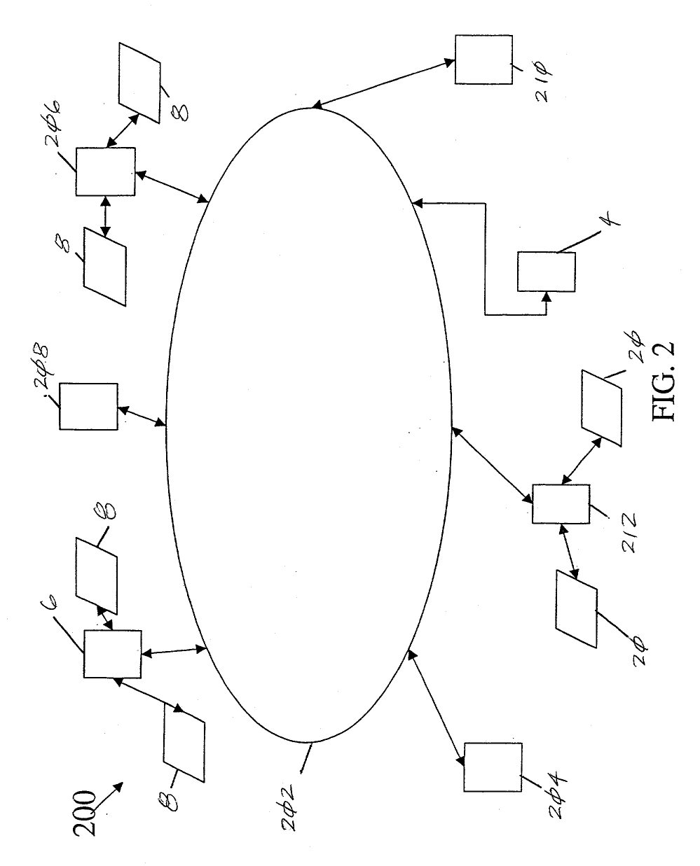

Referring now generally to the Figures and particularly to FIG. 2, a distributed computing embodiment of the method of the present invention, or distributed system 200, is comprises a computer network that includes a communications network, a network interface device, the wireless network interface device of FIG. 1, the first data source server of FIG. 1, a second data source server, a personalization server, a profile generator server, and a profile server. The wireless network interface device, or wireless device, is a computational device and has a wireless communications module, user input module, such a keyboard or a microphone, and a presentation device, such as a video display or an audio speaker. The network interface device, or user device, may be or comprise a personal computer or an information appliance. The user device contains a microprocessor and memory sufficient to receive, store and present the personalized report. In operation, the user, or the user device either automatically, or per a time schedule, or in response to an event or condition, initiates a request for data from the first data server or the second data server. Alternatively, data may be requested from both the first and second data servers. Alternatively or additionally, the first data server and/or the second data server may independently generate the report or reports having information and transmit the report to the personalization server, either automatically, or per a time schedule, or in response to an event or condition. The user may user the input module to initiate a request for information to the first data server. The report transmits from the first data server and/or the second data server via the communications network and to the personalization server. The communications network may be or include the Internet, an Intranet, an Extranet, a radio frequency communications network, a cell phone channel communications network, a wireless Internet communications modality or another suitable communications method or system known in the art. The personalization server receives the transmitted data or information and reformats the report into a personalized report by processing the received information with or via the personalization engine and in light of one of the profiles stored in the profile server. The personalization server then transmits the personalized report to the wireless device and/or the user device. The user device and/or the wireless device thereafter receives the personalized report and presents the personalized report to the user via the display module. Alternatively or additionally, the personalization engine may transmit personalized data to the user device and/or the wireless device, and the receiving device will then reformat the data to generate the personalized report. Various alternate preferred embodiments of the method of the present invention distribute the elements and steps, and optional elements and steps, of the method of the present invention in suitable functional and processing variations known in the art throughout the distributed system 200.

The distributed system 200 further comprises a profile generator, that can generate profiles on the basis of user replies to queries about the user's competencies, behaviors, financial resources or other suitable parameters known in the art. The profile generator may optionally, and in singularity or in combination with user-supplied responses, generate a user profile on the basis of information acquired from third party sources, such as credit ratings or medical records.

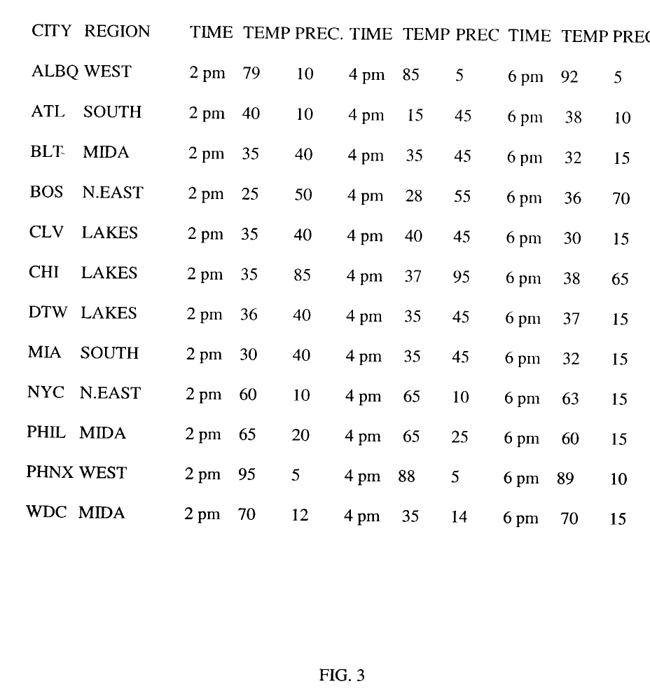

Referring now generally to the Figures and particularly to FIG. 3, a report generated by the first data source server of FIGS. 1 and 2 has a listing of cities and associated information as forecasted to occur at several times. The information is ordered in CITY lines, where each row of data all refers to the denoted CITY. The associated information comprises forecasts of air temperature at ground level expressed in degrees Fahrenheit and the likelihood of precipitation expressed as percentages. The report associates each CITY value with a single REGION, and associates each CITY with a plurality of TIME, TEMP & PREC values. TIME denotes the forecasted time that the associated temperature, or TEMP, and precipitation, or PREC, are directed to. CITY and REGION denote the municipality and region within the United States of America that each forecast is directed.

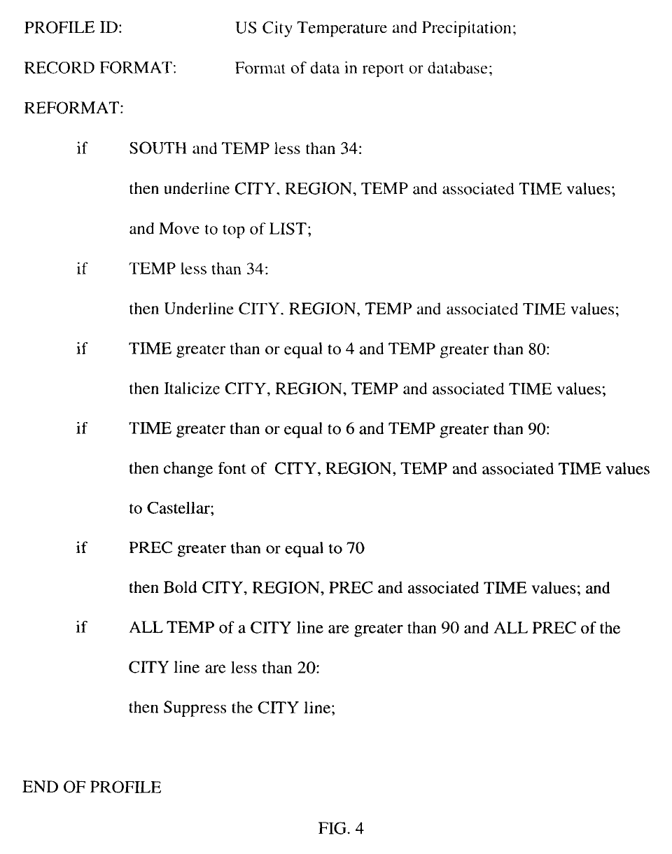

Referring now generally to the Figures and particularly to FIG. 4, a user profile informs the personalization engine of FIGS. 1 and 2 of what information types of the report of FIG. 3 is of special interest to the user. The profile will inform the personalization engine of the following rules to enforce when reformatting and personalizing the report of FIG. 3:

1. when a CITY in the SOUTH REGION has a TEMP value less than 34 degrees Fahrenheit, than UNDERLINE the CITY, REGION, TEMP and TIME values, and move the CITY data line to the top of the personalized report;

2. When a TEMP value is less than 34 degrees Fahrenheit, then UNDERLINE the associated CITY, TEMP and associated TIME values. (NOTE: this rule number has a broader but less dramatic effect than the application of rule number one.)

3. When a TEMP value greater than 80 degrees Fahrenheit occurs with an associated TIME value of 6 pm or greater, than ITALICIZE the CITY, REGION, TEMP and associated TIME values;

4. When a TEMP value greater than 90 degrees Fahrenheit occurs with an associated TIME value of 6 pm or greater, than change the font of the CITY, REGION, TEMP and associated TIME values to the font of Castellar;

5. When a PREC percentage likelihood is greater or equal to 70, then display the CITY, REGION, PREC and associated TIME values in bold; and

6. when a CITY has all TEMP values at greater than 90 degrees Fahrenheit, and all PREC values at less than 20 percentage of likelihood, then omit the entire line of CITY information.

The rules above are referred to herein by the ordinal numbers assigned to each rule in the above paragraph.

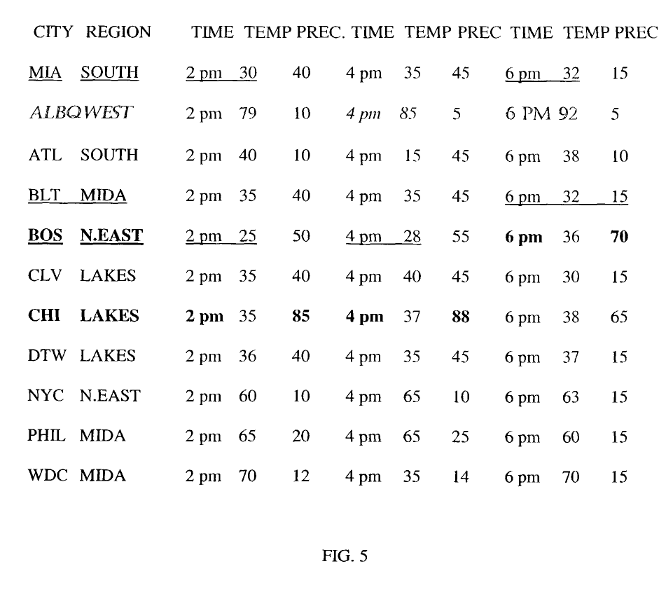

Referring now generally to the Figures and particularly to FIG. 5, a personalized report is generated by the personalization engine of FIGS. 1 and 2 and in light of the user profile of FIG. 4 and as processed in combination with the report of FIG. 3. The personalized report includes the following reformatting features, as directed by the profile of FIG. 4 and as executed by the personalization engine in reformatting the report of FIG. 3:

The CITY line for MIA, i.e. Miami, has been located in the beginning of the report, as per rule one, and the CITY, REGION and certain TIME and TEMP values have been underlined, as per rule numbers one and two.

The CITY and REGION values for Baltimore and Boston, i.e. BLT and BOS respectively, and relevant TIME and TEMP values have been underlined, as per rule number two.

The CITY, REGION and the 4 pm TIME and associated 85 degrees Fahrenheit TEMP values of ALBQ, i.e. Albuquerque, have been placed in italics, as per rule number three. In addition, The CITY, REGION and the 6 pm TIME and associated 92 degrees Fahrenheit TEMP values of ALBQ have been displayed in the Castellar font, as per rule number four.

The CITY and REGION values for Boston and Chicago, i.e. BOS and CHI respectively, and relevant TIME and PREC values, where PREC is greater or equal to 70 percent, have been presented in bold type, as per rule number five.

The information line for Phoenix, i.e. PHNX, has been omitted in the personalized report of FIG. 5, as per rule number six. The CITY line for Phoenix shows all TEMP values above 90 degrees Fahrenheit and all PREC likelihood percentages below 20. Rule number six therefore directs the personalization engine to omit, and not display, the CITY line for Phoenix in the personalized report.

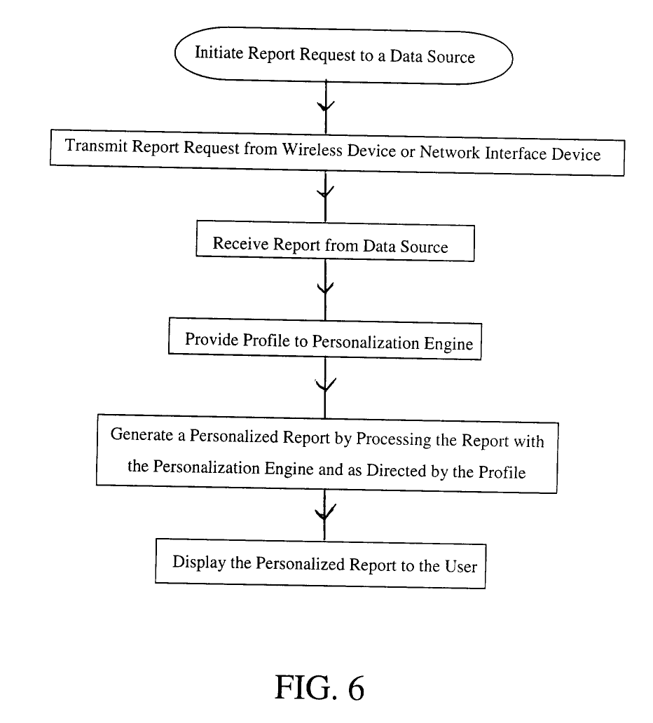

Referring now generally to the Figures and particularly to FIG. 6, a flow chart of the method of the present invention includes the preferred embodiment of the method of the present invention as actualized in various alternative embodiments of the present invention and described in the Figures. In one preferred embodiment, the user issues a request for a report to the first data source server from the wireless network interface device. The request is transmitted via the wireless communications link. The first data source server responds to the user request and generates and transmits the report to the wireless device via the wireless communications link. The wireless device than accept the report and provides the report and the profile to the personalization engine. The personalization engine then generates a personalized report by reformatting and modifying the report in accordance with the directions and information contained in the profile. By this method of the present invention, a first data source server may meet efficiently and effectively meet the informational need of a population of users by provide standardized or common reports to the population, and individual members of the population may have the report processed into a personalized report that improves the usefulness of the present invention to individuals receiving the personalized reports.

Certain alternate preferred embodiments of the present invention access a plurality of data sources and generate the personalized report, or a plurality of personalized reports, using information provided from more than one or from a plurality of data bases, data sources or reports.

Certain still alternate preferred embodiments of the present invention are designed to issue or receive the report without the issuance by the user of the report request or query. The reports may be generated on the basis of a pre-established schedule, such as every twelve hours, or in response to an event or condition, such as an increased likelihood of precipitation, or by direction of a third party.

Certain yet alternate preferred embodiments of the present invention provide two or a plurality of profiles. The selection of one profile enables the preferred embodiment of the present invention to generate a personalized report in light of external factors. By illustration, consider a pilot requesting a personalized weather report regarding a certain flight path. The pilot may have two or more profiles that are related to the choice of aircraft selected for the flight. The pilot can have a rotary wing profile and a jetcraft profile, or a plurality of profiles that are specific to an aircraft model or a particular aircraft. Optionally, third parties may be enabled to modify the profile, for example where an aircraft mechanic can modify the profile in relationship to the mechanic's evaluation of the flight worthiness of an aircraft.

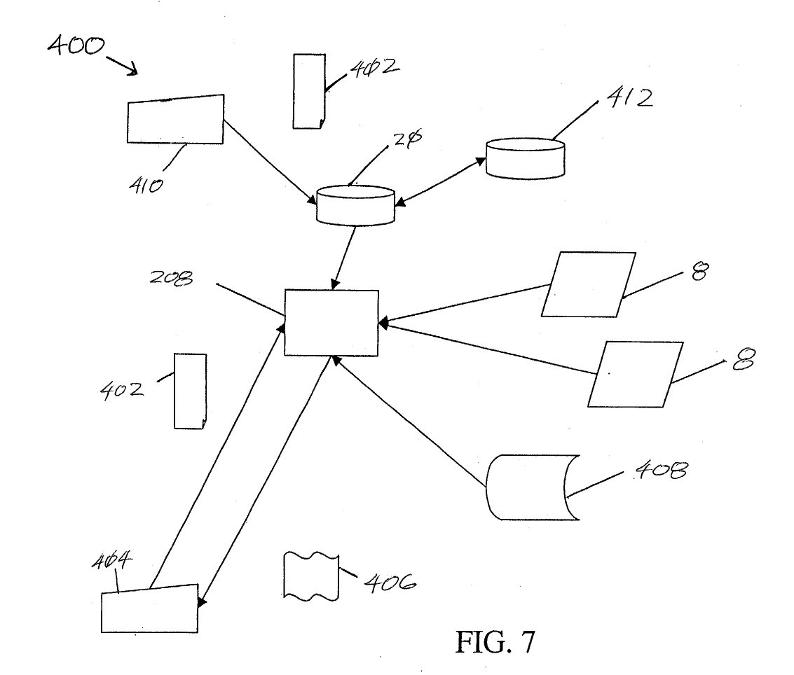

Referring now generally to the Figures and particularly to FIG. 7, an alternate preferred embodiment of the method of the present invention, includes the invented process 400. The invented process 400 includes the provision of profile data by the user, which is later followed by a request for a personalized report from the user to a personalization engine. The personalization engine receives reports or data from one or more data sources, and creates a personalized report in consideration of one or more system parameters, a stored profile and the data and reports received from the data sources. Additionally, the profile data may be combined with profile formats or profile descriptions received from the profile description server. A profile data combination or combinations may then be input into the personalization engine and be useful in the personalization process. The personalization process may include computational steps, wherein new values are derived and optionally reported in the personalized report. The personalization engine generates the personalized report and transmits, the personalized report to the user.

Referring now generally to the Figures and particularly to FIGS. 8A, 8B, 8C and 8D, FIG. 8A presents WXpert profile settings entered by a user and via the an Internet website, such as the enflight.com website. WXpert is a software tool that generates aeronautically oriented personalized reports and is available via the enflight.com website. WXpert is a weather information translator/personalization engine that evaluates the weather based on the user's own personal minimums. WXpert helps the user rapidly determine areas of weather you might want to avoid, based on your own flying skills.

FIG. 8D presents a terminal weather forecast as generated for a general audience. FIG. 8C shows software generated plain language report that contains the weather data presented in FIG. 8D. FIG. 8B presents a personalized report generated by WXpert and using the profile data of FIG. 8A and the standard report of FIG. 8D. The standard terminal weather report as generated and transmitted over the Internet is very difficult to read for information, as the following excerpt from FIG. 8D illustrates:

TAF KMKC 190536Z 190606 01012G24KT P6SM SCT012
BKN050 TEMPO
0709

VRB25G55KT 3/4SM +TSRA OVCO10CB
FM0900 17006KT P6SM VCTS SCT050CB BKN120 TEMPO 0912

5SM

-TSRA BKN050CB
FM1200 18010KT P6SM BKN050 PROB40 1215 5SM -TSRA
BKN050CB
FM1500 22008KT P6SM SCT120 BKN200

A quick comparison with the plain language report of FIG. 8C shows the advantages of raising the readability of the standard report. The personalized report of FIG. 8B permits the user to most effectively determine the critical information contained in the original standard report.

Referring now generally to the Figures and particularly to FIGS. 8A, 9A, 9B and 9C, several personalized METARS reports are displayed in FIG. 9A. FIG. 9C presents METARS reports regarding current weather conditions. The personalized reports of 9A are generated by the personalization engine of the Enflight.com website. The data of FIG. 9C and the profile data of FIG. 8A are used by the personalization engine to generate the personalized METARS reports. The personalized reports of FIG. 9A were generated with WXpert enabled. FIG. 9B presents plain language translations of the METARS reports of FIG. 9C, but without the use of the WXpert personalization engine.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

I claim:

1. A method for generating a personalized report from at least one datum received from a data source by a network interface device, the method comprising:
establishing a user profile, the profile specifying at least one value and associating the at least one value with the at least one datum;
providing the at least one datum to a personalization engine, the personalization engine for including the at least one datum for presentation to a user;
providing the user profile to the personalization engine;
generating a personalized report by data processing the report with the personalization engine in accordance with an information and the at least one value contained in the profile; and
presenting the personalized report to the user by means of a display device.

2. The method of claim 1, wherein the method further comprises a plurality of values contained in the profile and a plurality of data provided from the data source to the personalization engine, and including the plurality of data in the personalized report.

3. The method of claim 1, wherein the at least one value comprises a numerical value and the personalization engine compares the numerical value with the at least one datum and indicates a result of the comparison in the personalized report.

4. The method of claim 1 wherein the personalized report comprises indication means for presenting the at least one datum to the user from the group that includes character color, background color, bold face, italicization, underlining, font selection, point sizing and location within the personalized report.

5. The method of claim 1 wherein the personalized engine suppresses the at least one datum and omits the at least one datum from the personalized report.

6. The method of claim 1 wherein the personalized report comprises an altered order of presentation of the at the at least one datum in the personalized report.

7. The method of claim 1 wherein the personalized report data presents the at least one datum in a graphic representation.

8. The method of claim 1 wherein the personalized report data presents the at least one datum in a graphic table.

9. The method of claim 1 wherein the personalized report presents the at least one datum in an audio transmission.

10. The method of claim 1 wherein the personalized report presents the at least one datum in a tactile communication.

11. The method of claim 1 wherein a plurality of the at least one datum are provided to the personalization engine from a plurality of data sources, and the personalized report includes the plurality of at least one value in the personalized report.

12. The method of claim 1, wherein a plurality of profiles are available to the personalization engine, and one profile is selected for use in generating the personalized report.

13. The method of claim 1, wherein the user request the personalized report.

14. The method of claim 1, wherein the personalized report is generated according to a pre-set schedule.

15. The method of claim 1, wherein the personalized report is generated in response to a third party command.

16. The method of claim 1, wherein the personalized report is generated in response to an occurrence of a condition.

17. The method of claim 1, wherein the personalized report is generated in response to a detection of an event.

18. The method of claim 1, wherein the profile is modified by a third party.

19. The method of claim 1, wherein the profile is generated by a profile generator.
